(19) United States
(12) Patent Application Publication
(10) Pub. No.: US 2006/0099392 A1
(43) Pub. Date: May 11, 2006

(54) Stretchable thermoplastic resin film, for use in the packaging of food

(75) Inventor: Lorenzo Francesconi, Monte San Quirico (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: Vismore Company S.A., Montevideo (UY)

(21) Appl. No.: 10/533,864

(22) PCT Filed: Nov. 5, 2003
(86) PCT No.: PCT/IT03/00716

§ 371 Date: Oct. 20, 2005

(30) Foreign Application Priority Data
Nov. 5, 2002 (IT) FI2002A000213

(51) Int. Cl. B32B 27/08; B32B 27/32; B32B 27/30

(52) U.S. Cl. 428/216; 428/522; 428/500; 428/523; 428/521; 428/520

(57) ABSTRACT

The film comprises an inner thickness of polyvinyl chloride (PVC) with polymer plasticizers, coextruded with two thin outer layers of synthetic resins of ethylene-vinylacetate (EVA) or stretchable polystyrene (PS) or other thermoplastic materials which are non-toxic and capable of preventing the transmission of particles present in the PVC.

The wrapping or packaging of fresh products—such as meats, cheeses, fruit, vegetables and various other products—in supermarkets or packaging centres has hitherto been carried out using stretchable plasticized PVC (polyvinyl chloride) film, which is applied to polystyrene, wood pulp, or cardboard trays and similar containers of rigid plastic.

Stretchable PVC film is known as “stretch” film or “cling film”.

In order to obtain the appropriate and necessary chemical/physical and mechanical characteristics for stretchable PVC film it is necessary to add many other chemical substances to the PVC-based thermoplastic resin such as
stabilizers to light and heat,
monomer and/or polymer plasticizers,
internal and external lubricants,
coloring agents, etc.

The mixtures or “compounds” so obtained are then extruded using systems known in the art, carried out using various top down or bottom up extrusion technologies, with a rotating extrusion head or rotating collection calendar or rotating extruder platform. All these systems have been known to those skilled in the art for a long time.

The stretchable PVC film must have special characteristics, including those shown in the table below. Particularly important is permeability to oxygen, as the film must maintain the bright red color of fresh meat during the normal period of exposure to the public for sale. The choice and quantity of plasticizers is important for achieving this characteristic.

### Special Characteristics of Stretchable PVC Film

| | UNITS OF | | ASTM |
|---|---|---|---|
| PROPERTY | MEASUREMENT | FILM | METHOD |
| Thickness | μm | 10 | — |
| Specific gravity | Kg/dm³ | 1.25 | — |
| Tensile strength | Kg/cm² | 270-340 | D882 |
| Elongation on fracture | % | 190-280 | D882 |
| Tear strength | g | 110-150 | D1004 |
| Opacity | % | 90-92 | D1003 |
| Permeability to water | g/m²/24 H | 300-400 | E96-66 |
| vapor | | | |
| Permeability to | cm³/m²/24 H/atm | 8000-10000 | D1434 |
| oxygen | | | |

Recently there has arisen the problem that some monomer plasticizer substances in general and phthalates (DOP, dioctyl phthalate, and the like) and adipates (DOA, (dioctyl adipate, and the like) in particular appear to be carcinogenic. Unfortunately all these types of monomer plasticizers migrate from the film to the wrapped product and this can be harmful to the health of consumers.

Plastics films (second edition), John H Briston, states the following.

“Up to a certain point the properties of the plasticized PVC film depend on the type of plasticizer used, and the quantity. In general, increasing the quantity of plasticizer increases the softness of the film and also improves its low temperature properties. PVC films can be obtained with excellent gloss and transparency, provided that the correct stabilizers and plasticizers are used.

It is also possible to print on both types of film (plasticized and non-plasticized films), but some plasticizing agents and lubricating agents tend to migrate towards the surface and can cause detachment of the inks.

Much plasticized PVC is used in thicknesses greater than 250 μm and should therefore in reality be classified as “sheets”. Applications for thin plasticized PVC films mainly arise in the packaging field. Thin plasticized PVC film (10-25 μm) is widely used in supermarkets for the elastic packaging of trays containing slices of fresh meat The requirements for this type of film are quite strict. The film must have a sufficiently high permeability to oxygen to permit formation of the oxymyoglobin which provides the desired “vivid” purple color of fresh red meat. The film must also be capable of withstanding low temperatures, be stretchable and have good transparency and gloss. The low permeability of rigid PVC to oxygen is increased by plasticization and the strength of the PVC makes it possible to use thin thicknesses, thus further increasing permeability to gases. A similar application is the wrapping of supermarket trays for fresh products such as fresh meat, tomatoes, apples and others. The rate at which the vapor from the moisture of the packaged product is transmitted through the PVC is useful to prevent condensation within the film.”

Plastics Films (second edition), John H. Briston, states the following:

“Migration is the transfer of substances between plastics and food. This can take place in two ways, from the plastic to the food, which is the normally accepted understanding, or from the food to the plastic, which can be defined as negative migration.

Plastics are the newest group among packaging materials, and therefore are regarded with some apprehension by consumers and the authorities. This has been appreciably accentuated by the discovery in the early 1970s of vinyl chloride monomer in significant quantities in foods wrapped in PVC (it was noted for the first time in alcoholic drinks contained in small bottles for use on airlines), and this coincided with the discovery that the monomer is a carcinogen if inhaled.

Plastics are certainly highly complex, and contain many chemical species. Theoretically migration could occur with a large number of different components. This applies to other packaging materials and, to a lesser extent, attention has also been paid to these.

Most legislation or regulations consider migration and the quality of the residue, rarely other vectors.”

As mentioned above, the problem of the plasticizers which are essential for stretch PVC film has arisen in recent years. It is worthwhile pointing out that monomer plasticizers, like DOP and DOA, can be wholly extracted from the film, according to the laboratory test techniques currently in use, using for example a vegetable oil as solvent.

It is useful to consider the details of plasticizers:

Types of plasticizers (from PVC Technology by W. S. Penn, B.Sc., London, Maclaren and Sons Limited):

“The plasticizer converts the PVC polymer from a hard resin to a flexible compound and this underlies all flexible PVC technology.

Plasticizers may be monomers or polymers. There are hundreds of the former and conversely few of the latter, which are above all used where the compounds require satisfactory heat ageing and resistance to liquids.

Plasticizers can be subdivided into some quite well-defined groups. By far the largest of these, group 1, includes esters of phthalic anhydride. These have good general properties, including suitable low temperature properties and good facility for incorporation into resins.

A defect is that these do not yield compounds with good flame resistance, so that group 2 the phosphates, have recently been the more popular group. They also have the advantage of comparative cheapness. In the first group dioctyl phthalate (DOP) and diisooctyl phthalate (DIOP) are popular, and in group 2 tricresyl phosphate (TCP), now referred to as tritolyl (TTP), is perhaps the most common plasticizer.”

[These types of plasticizers, in addition to not being capable of use, because they are wholly extractable both as a single layer film and as film coextruded in three layers, have been declared carcinogenic in recent years.] “Plasticizers in group 3 are used for low temperature applications and include adipates, sebacates and azelates. Examples of these are dioctyl sebacate (DOS), dibutyl sebacate (DBS), dibutyl adipate (DBA), dioctyl adipate (DOA) and diisooctyl azelate (DIOZ).”

In this group the most widely used was DOA, which has recently been prohibited in Italy—and only in Italy—because it is suspected of being carcinogenic. However all are highly extractable, like the former.

“Plasticizers in group 4 include polymer types which are polyesters of sebacic, adipic and azelaic acids and glycols and others. A good example is polypropylene adipate.”

The theories explaining the behavior of plasticizers are complex and there is no need to consider them in detail. They can be conveniently summarized for the sake of completeness.

Molecules of resin are held together by strong Van Der Waals forces and the function of plasticizers is to get in the way of these forces to weaken them, thus enabling molecules to slide more easily with respect to each other. This is widely accepted by the various theories, but it is the nature of the bonds which hold the resin to the plasticizer which causes the real controversy.

It is almost certain that small quantities of plasticizer are firmly held by the resin, but with increased plasticizer content the forces holding the plasticizer become increasingly weaker. This feature is well illustrated by the fact that the percentage of plasticizer extracted by vegetable oil or by heat is very low in comparison with the plasticizer contained, that is in comparison with the plasticizer which is held by strong Van der Waals forces.

As mentioned above, Italian and European legislation has recently prohibited the use of some types (the most widely used types) of monomer plasticizers.

Manufacurers of such films have complied with the statutory provisions by varying the nature of the monomer plasticizers, but this does not prevent other substances—which seem to be recognized as being atoxic—from migrating into the packaged product, giving out substances which are at the least foreign to the packed food and which could nevertheless be to a greater or lesser extent harmful. In any event the film is not inert.

The object of this invention is to keep PVC film stretchable, and therefore suitable for use, but to render it inert, that is ruling out the risk of the transfer of foreign substances to the packed foodstuff.

Many attempts have been made to achieve the above object by those in the sector of plastic converters, with the replacement of stretchable PVC film by various films of polyethylene (PE) or other stretchable plastics materials, and also by using bubble or flathead coextrusion systems in two or more layers, up to five, in addition to monoextrusion. But so far no positive results have been achieved. This may be due to the nature of the plastics materials used, the absence of both mechanical and chemical properties such as the right and balanced permeability to O₂, CO₂ and H₂O (as mentioned above), as well as a lack of elastic memory and poor tensile strength of the film during the packaging stage, which is mainly automatic. In fact with polyethylene and other films major problems have arisen in connection with the use of automatic or semi-automatic machines, and even manual machines.

Substantially the subject of the invention is a stretchable film of synthetic resin which can be used for the packaging of food, characterized in that it comprises a main layer of polyvinyl chloride (PVC) with plasticizers of the polymer type and at least one thin outer thickness or two opposite thin outer thicknesses of synthetic non-toxic thermoplastic resins capable of preventing the transmission of particles present in the PVC.

Production of the abovementioned article can easily be achieved using the coextrusion technique.

The said thin outer thickness or thicknesses may comprise plastics substances included in the group comprising: ethylene-vinyl acetate (EVA), expandable polystyrene (PS), polyethylene (PE), ionomer resins (Surlyn), polybutadiene and other thermoplastics.

Thus according to the invention it is provided that the predominant presence of PVC with the chemical and physical properties which are specific to this material should be retained and—in order to overcome the problems of the transfer of substances added to the PVC resin (which would migrate directly from the film to the packaged product) and to maintain the special characteristics of the stretchable PVC film—the stretchable PVC film is coextruded through bubble or flathead with another or two other opposite (minimal) layers outside the PVC of other thermoplastics materials such as ethylene-vinyl acetate (EVA), stretchable polystyrene (PS, of the Styroflex type from BASF), ionomer resins such as “Surlyn” (from DuPont), polybutadiene, and various others which prevent the migration of particles present in the PVC and which are not toxic, as envisaged by the present legislation substantially adopted in many countries.

Advantageously the polymer plasticizers which can be used to implement the invention are polyesters of sebacic, adipic and azelaic acids, and glycols, because, in addition to being non-toxic and therefore capable of use in contact with foods, they are non-extractable on account of their high molecular weight and their chemical nature.

It has been established that the higher the quantity of plasticizer used, the softer the film and therefore the more it will stretch.

According to the invention, the minimum quantity of polymer (and non-monomer) plasticizer which has to be used is 38% with respect to the weight of PVC resin. The example clarifies this better:

Use of Different Quantities of Propylene Adipate (PPA)

| Polymer plasticizer | Tensile strength | |
|---|---|---|
| PHR | psi | BS softness No. |
| 20 | 3100 | — |
| 30 | 2630 | — |
| 40 | 1860 | 19 |
| 50 | 1170 | 36 |
| 60 | | 48 |

The softness shows that as the quantity of plasticizer increases the stretchability of the film, a characteristic which is essential for implementing the invention, increases.

Coextrusion may be limited to two layers only, a main layer of polyvinyl chloride (PVC) with polymer plasticizers and a thinner outer thickness of thermoplastic synthetic resins, which protects against the diffusion of contaminating substances towards the product packaged with the material in question. More advantageously the coextrusion may be performed using three layers in order to have protection on both the surfaces of the extruded material, the stretchable PVC film being an internal structure, plasticized with polymer plasticizers, and therefore isolated. With only two layers there is contact between the protective layer and the PVC when stored as a roll; this is effectively not harmful at the time of packaging, because the polymer additives contained in the PVC are not transmitted into the protective layer on contact, but it is necessary to use a specific side in contact with the products being packaged.

In essence it is necessary to achieve a structure with PVC on the inside, and of sufficient thickness, minimum 8 μm and maximum 20 μm, to ensure the physical/chemical properties which are specific to it, especially stretchability and elastic memory, and with an outer thickness or thicknesses of inert and the softer the film and therefore the more it will stretch.

According to the invention, the minimum quantity of polymer (and non-monomer) plasticizer which has to be used is 38% with respect to the weight of PVC resin. The example clarifies this better:

Use of Different Quantities of Propylene Adipate (PPA)

| Polymer plasticizer | Tensile strength | |
|---|---|---|
| PHR | psi | BS softness No. |
| 20 | 3100 | — |
| 30 | 2630 | — |
| 40 | 1860 | 19 |
| 50 | 1170 | 36 |
| 60 | | 48 |

The softness shows that as the quantity of plasticizer increases the stretchability of the film, a characteristic which is essential for implementing the invention, increases.

Coextrusion may be limited to two layers only, a main layer of polyvinyl chloride (PVC) with polymer plasticizers and a thinner outer thickness of thermoplastic synthetic resins, which protects against the diffusion of contaminating substances towards the product packaged with the material in question. More advantageously the coextrusion may be performed using three layers in order to have protection on both the surfaces of the extruded material, the stretchable PVC film being an internal structure, plasticized with polymer plasticizers, and therefore isolated. With only two layers there is contact between the protective layer and the PVC when stored as a roll; this is effectively not harmful at the time of packaging, because the polymer additives contained in the PVC are not transmitted into the protective layer on contact, but it is necessary to use a specific side in contact with the products being packaged.

In essence it is necessary to achieve a structure with PVC on the inside, and of sufficient thickness, minimum 8 μm and maximum 20 μm, to ensure the physical/chemical properties which are specific to it, especially stretchability and elastic memory, and with an outer thickness or thicknesses of inert and non-harmful resins with a minimum of 2 μm and a maximum of 5 μm.

Coextrusion may be effected in three or more layers, which may be carried out as normal extrusion, from the top down or vice versa from bottom up, in the case of bubble extrusion, and rotating any part of the extrusion line to obtain uniform thickness.

A number of coextrusion schemes are specified below as examplary embodiments.

As already mentioned, the invention cannot be implemented using monomer plasticizers (groups 1, 2, 3), but only using polymer plasticizers (group 4).

As examples of polymer plasticizers the HEXAPLAS plasticizers manufactured by I.C.I. may be used. HEXAPLAS PPA is based on polypropylene adipate. This long chain molecule has very low volatility, high resistance to solvent extraction, and is virtually non-migrating. These advantages are important, but there are also some disadvantages. Because of its high molecular weight and viscosity, it has poorer plasticization and combination properties. In order to partly overcome this difficulty it is necessary to use higher temperatures and longer mixing times.

Another type of polymer plasticizer which can be used to produce a stretchable PVC film according to the invention in coextrusion with EVA is Santicizer 438 from Monsanto, which has the following properties:

Characteristic Physical Properties

| Appearance | Yellow viscous liquid |
|---|---|
| Acid value | 2.5 |
| (MEQ KOH/100 g) | |
| APHA color (max) | 250 |
| Refractive index at 25° C. | 1.480-1.485 |
| Specific gravity at 25° C. | 1.10 |
| Viscosity at 25° C. (poise) | 26-38 |

PVC Applications (1 mm Film at 67 PHR)

| | |
|---|---|
| PVC solvic 271 GA | 100 |
| Plasticizer 438 | 67 |
| Mark WS (Argus Chem.) | 1 |
| Stearic Acid | 0.4 |

Results of the Test with Santicizer 438

| | |
|---|---|
| Shore “A” hardness | 81 |
| Tensile strength (kg/cm²) | 188 |
| 100% modulus (kg/cm²) | 110 |
| Low temperature flexion T(° C.) | −10.2 |
| Volatility in activated carbon at 87° C. | 3.8 |
| for 6 days (% plasticizer lost) | |

Another example of polymer plasticizer which can be used in this invention is Priplast 3149 from Unichema International.

Priplast 3149 is a polyester polymer plasticizer based on azelaic acid and propylene glycol having a molecular weight of approximately 6000. It has a high viscosity which provides the PVC with excellent resistance to oil and petroleum.

Extraction values in comparison with DOP are shown below.

| | | % loss | Priplast | |
|---|---|---|---|---|
| Extraction values | | of weight | 3149 | DOP |
| Detergent | 7 days at 50° C. | — | 1.4 | 6.1 |
| Mineral oil | — | — | +7.1 | 8.1 |
| Soya oil | — | — | 0.3 | 12.2 |
| Hexane | 1 day at 23° C. | — | 0.9 | 24.9 |
| Gasoline | — | — | 0.7 | 19.9 |

With what has been described, the mechanical properties of the film which are specific to PVC, especially the elastic memory, stretchability, tensile strength and chemical properties such as balanced permeability to atmospheric agents such as O₂, CO₂, H₂O, remain virtually unchanged.

This is very important, because in this way the range of machines present on the market can still be used. However the packed products—like fresh meat, cheese, etc.—remain free from foreign substances, which cannot be yielded up by the PVC packaging film because of the isolation provided by the two outer layers of the sandwich. Fresh meats remain unchanged, even in color, on account of the permeability to oxygen offered by the film according to the invention.

Film of two or three or more layers can advantageously have “antifog” substances (lipophilic and hydrophilic anticondensation agents) added to it so as to make the multiple film completely transparent.

As a practical embodiment of the product according to the invention the most common is the EVA/PVC structure or EVA/PVC/EVA, where an EVA with a vinyl acetate content of less than 10% is used because otherwise, if it were greater than 10%, the bubble would be so tacky that it would no longer be possible to handle it after extrusion and it would not be possible to wind the film onto spools because the turns would adhere to each other, and it would be impossible to unroll them.

The properties of the type “Escorene Ultra” from “Esso Chemicals” may be mentioned as an example of useful EVAs, as shown by the types listed below.

| | | | |
|---|---|---|---|
| | | Units of | |
| Properties | Method of test | measurement | Values |

UL 00929-CC (EVA)

| | | | |
|---|---|---|---|
| Melting index | ASTM D 1238 | g/10 min | 9 |
| Density | ASTM D 1505 | g/cm³ | 0.926 |
| Vinyl acetate | Essochem Plastics | % | 9 |
| content | | | |
| Additives | | | |
| Slip | — | Level | None |
| Antiblock | — | Level | None |
| Antifog | — | Level | High |
| VICAT softening | ASTM D 1525 | ° C. | 72.9 |
| point | | | |
| MVTR barrier | 25 μm 90% RH- | g/m²/24 H | 67 |
| property | 38° C. | | |
| O₂ transmission | Gas | 10⁴cm³ STPμm | 19 |
| | chromatography | m²day ATM | |

UL 00209-CC5 (EVA)

| | | | |
|---|---|---|---|
| Melting index | ASTM D 1238 | g/10 min | 2.5 |
| Density | ASTM D 1505 | g/cm³ | 0.929 |
| Vinyl acetate | Essochem Plastics | % | 8.5 |
| content | | | |
| Additives | | | |
| Antiblock | — | Level | None |
| Slip | — | Level | None |
| Cling | — | Level | Very High |
| VICAT | ASTM D 1525 | ° C. | 80 |
| softening point | | | |
| Fogging | ASTM D 1003 | % | 2.0 |
| Gloss at an | ASTM D 2457 | % | 12.0 |
| angle of 60° | | | |
| Ultimate tensile | ASTM D 638 | N/cm² | |
| strength | | | |
| MD | | | 2550 |
| TD | | | 1700 |
| Elongation | | | |
| MD | ASTM D 638 | % | 460 |
| TD | | | 450 |
| 1% secant | ASTM D 638 | N/cm² | |
| modulus | | | |
| MD | | | 7600 |
| TD | | | 9500 |
| Dart fall impact | ASTM D | g | 230 |
| F₅₀ | 1709 (A) | | |
| Low | ASTM D 749 | ° C. | <−76 |
| temperature | | | |
| brittleness | | | |
| Recommended | — | Micrometres | 12-25 μm |
| range of | | | |
| thicknesses | | | |
| Recommended | — | ° C. | 110-130 |
| welding range | | | |

UL 00209

| | | | |
|---|---|---|---|
| Melting index | ASTM D 1238 | g/10 min | 2.0 |
| Density | ASTM D 1505 | g/cm³ | 0.929 |
| Vinyl acetate | Essochem Plastics | % | 8.5 |
| content | | | |
| Additives | | | |
| Antiblock | — | Level | None |
| Slip | — | Level | None |
| VICAT | ASTM D 1525 | ° C. | 80 |
| softening point | | | |
| Fogging | ASTM D 1003 | % | 2.5 |
| Gloss at an | ASTM D 2457 | % | 12 |
| angle of 60° | | | |
| Ultimate tensile | ASTM D 638 | N/cm² | |
| strength | | | |
| MD | | | 2530 |
| TD | | | 2535 |
| Elongation | | | |
| MD | ASTM D 638 | % | 500 |
| TD | | | 700 |
| 1% secant | ASTM D 638 | N/cm² | |
| modulus | | | |
| MD | | | 8900 |
| TD | | | 9700 |
| Dart fall impact | ASTM D | g | 320 |
| F₅₀ | 1709 (A) | | |
| Low | ASTM D 749 | ° C. | <−76 |
| temperature | | | |
| brittleness | | | |
| Recommended | — | Micrometres | 25-100 μm |
| range of | | | |
| thicknesses | | | |
| Recommended | — | ° C. | 120-160 |
| welding range | | | |

UL 00909

| | | | |
|---|---|---|---|
| Melting index | ASTM D 1238 | g/10 min | 9.0 |
| Density | ASTM D 1505 | g/cm³ | 0.926 |
| Vinyl acetate | Essochem Plastics | % | 9.0 |
| content | | | |
| Additives | | | |
| Antiblock | — | Level | None |
| Slip | — | Level | None |
| VICAT | ASTM D 1525 | ° C. | 73 |
| softening point | | | |
| Fogging | ASTM D 1003 | % | 4.0 |
| Gloss at an | ASTM D 2457 | % | 11.0 |
| angle of 60° | | | |
| Ultimate tensile | ASTM D 638 | N/cm² | |
| strength | | | |
| MD | | | 1950 |
| TD | | | 1900 |
| Elongation | | | |
| MD | ASTM D 638 | % | 470 |
| TD | | | 650 |
| 1% secant | ASTM D 638 | N/cm² | |
| modulus | | | |
| MD | | | 8150 |
| TD | | | 9250 |
| Dart fall impact | ASTM D | g | 165 |
| F₅₀ | 1709 (A) | | |
| Low | ASTM D 749 | ° C. | <−76 |
| temperature | | | |
| brittleness | | | |
| Recommended | — | Micrometres | 30-100 μm |
| range of | | | |
| thicknesses | | | |
| Recommended | — | ° C. | 120-160 |
| welding range | | | |

Increasing the incorporation of VA (vinyl acetate): improves
heat sealing strength
antiwrinkling properties
flexibility
low temperature performance
hot adhesiveness
adhesion
cohesion strength
solubility
opening time,
   and
   reduces
blocking resistance
maintenance of gloss
heat resistance.

A structure using polystyrene (PS), that is PS/PVC or PS/PVC/PS, may also be used in automatic or manual machines using a suitable type of welder.

This invention represents a substantial step forward and offers substantial advantages with respect to the known and published art.

In comparison with U.S. Pat. No. 6,214,477 of the 10 Apr. 2001 entitled “Multilayer film with polyolefin and polyvinyl chloride” by George D. Wofford, William P. Roberts, assignee: Croyvac, Inc., there are major and essential differences which among others include the following:
A heat-shrinking film is described, but the product according to this invention is solely stretchable,
A compound based on monomer plasticizers is envisaged for the PVC, but these cannot be used because they are considered to be carcinogenic and because they can be wholly extracted by common solvents used in the laboratory transfer test; according to the invention polymer plasticizers, which give rise to wholly negligible migration phenomena, are used instead,
The percentage of polymer plasticizers according to the invention is clearly greater than the percentage of plasticizers in the aforesaid prior patent,
In said prior patent a percentage of EVA having a vinyl acetate content of 10% to 35% is used, which makes the surface very tacky, as a result of which it is not possible to use bubble extrusion but only flat head extrusion, and winding is not possible; according to this invention on the other hand an EVA with a content of less than 10% of vinyl acetate is used.

With respect to U.S. Pat. No. 4,855,181 of the 8 Aug. 1989 entitled “Laminate with a blend layer of polyester amide and ethylene-vinyl acetate copolymer” by Hiroyuki Shimo, Issao Kanesige, Nobuo Tanaka, assigned to Kuraray Co., Limited, the substantial differences in comparison with this invention are: this relates to a coupled film of great thickness, over 250 μm; coextrusion is not envisaged for it; it is not stretchable but is a laminate/coupled material to be used as a gas barrier film; only two layers are provided, while the product according to this invention provides for at least three layers, with two opposite protective layers outside the PVC.

In clarification of this invention a drawing is appended in which:

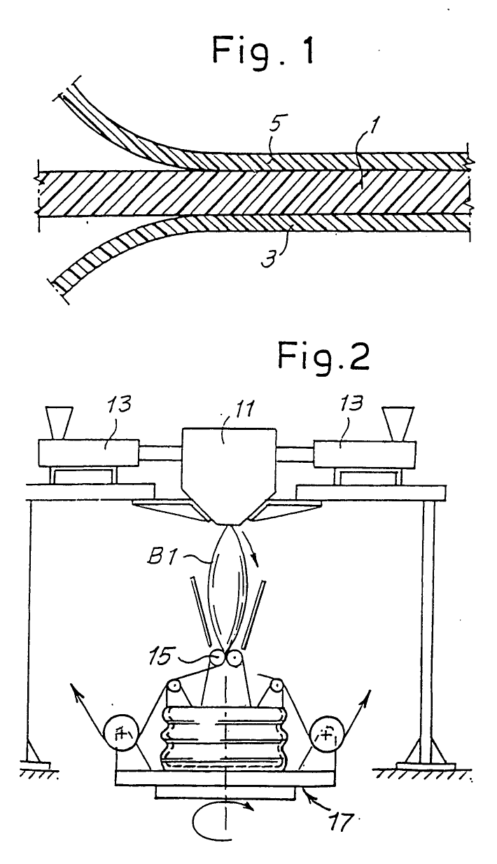

FIG. 1 shows a three layer film constructed according to the invention, highly magnified,

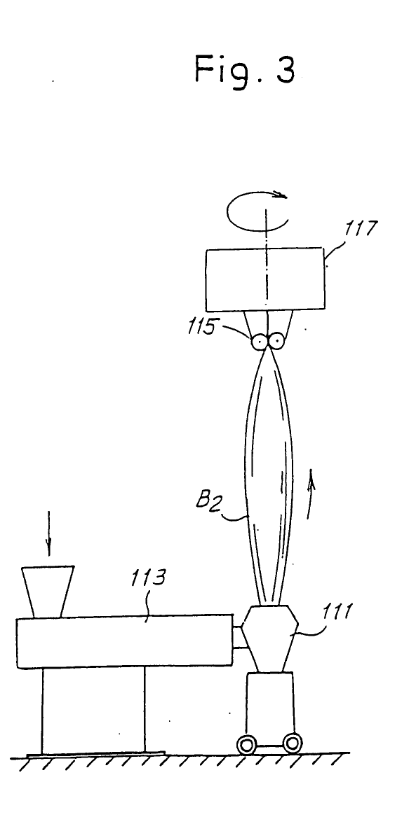

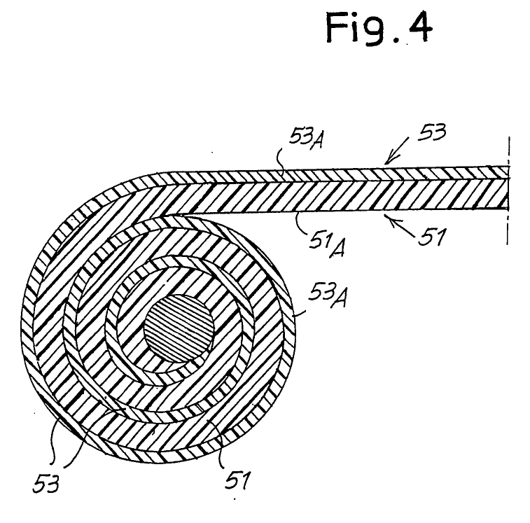

FIGS. 2 and 3 show summary coextrusion schemes for making film according to the invention of the stretchable type,

FIG. 4 shows a two layer film constructed according to the invention.

In FIG. 1, 1 indicates the inner thickness of extensible polyvinyl chloride (PVC) with various additives including plasticizers exclusively of the polymer type, and 3 and 5 indicate two thin layers of EVA and/or stretchable polystyrene (PS) and/or other synthetic resins which are the same as or different from each other. The thickness of layer 1 is of the order of 8 μm to 20 μm; the thickness of layers 3 and 5 is of the order of 2 μm to 5 μm.

FIG. 2 shows a diagram of a plant with a coextrusion head 11, in which 13 indicates two of the three or four or more extruders feeding the same head with concentric annular orifices. Bubble B1 which develops towards the bottom passes between two rollers 15 and can be collected by a rotating unit 17 to render the thickness of the stretchable film uniform. The material can be wound on spools or cut longitudinally and wound onto two different spools.

FIG. 3 shows a diagram of a plant with an extrusion head 111, in which 113 indicates one of the extruders feeding it with concentric apertures. Bubble B2 develops upwards to reach a group of rollers 115, beyond which the material can be collected as a stretchable film in 117. Provision is also made for rotation in this arrangement.

In FIG. 4, 51 shows a main thickness comprising polyvinyl chloride (PVC) and 53 indicates the thinner single protective thickness of EVA or other material which is coextruded with the main thickness 51 of PVC. During winding, as may be seen in FIG. 4, the exposed surface of protective layer 53 comes into contact with exposed surface 51A of thickness 51; however the virtually zero migration of polymer plasticizers included in thickness 51 rules out any contamination of surface 53A which will come into contact with the products being packed.

It is to be understood that what has been described and the drawings represent non-restrictive examples only provided as practical embodiments of the invention, and that this invention may vary in its implementation and arrangements without going beyond the scope of the essential concept of the invention itself.

1. A stretchable synthetic resin film which can be used for the packaging of foodstuffs, characterized in that it comprises a main layer of polyvinyl chloride (PVC) with a high content of exclusively polymer plasticizers of the PPA type and the like, and at least one thin outer layer of non-toxic thermoplastic synthetic resin capable of preventing the transmission of particles present in the PVC.

2. A stretchable synthetic resin film, which can be used for the packaging of foodstuffs, characterized in that it comprises an inner layer of polyvinyl chloride (PVC) with a high content of exclusively polymer plasticizers of the PPA type and the like and at least two opposite thin outer layers of non-toxic thermoplastic synthetic resin capable of preventing the transmission of particles present in the PVC.

3. Film according to claim 1, characterized in that said outer thin layer or layers are comprised of substances included in the group of resins such as ethylene-vinyl acetate (EVA), stretchable polystyrene (PS), polyethylene (PE), ionomer resins, polybutadiene, and the like.

4. Film according to claim 1, characterized in that the main layer has a thickness of the order of 8 tm to 20, um and the thin outer layers have thicknesses from 2, um to 5 p, m.

5. Film according to claim 1, characterized in that the polymer plasticizer in the intermediate layer of PVC is present in a quantity of at least 38% or more with respect to the PVC (by weight).

6. Film according to claim 4, characterized in that the polymer plasticizer present in the principal thickness is selected from one or more of the group comprising polyesters of sebacic acid, adipic acid and azelaic acid and glycols.

7. Film according to claim 4, characterized in that the polymer plasticizer is selected from the plasticizers HEXAPLAS and SANTICIZER 438 or mixtures of these and/or PRIPLAST 3149, and others.

8. Film according to claim 1, characterized in that an EVA with a vinyl acetate content of less than 10% is used for the thin outer layer or layers.

9. Film according to claim 1, characterized in that it comprises EVA-PVC-EVA.

10. Film according to claim 2, characterized in that it comprises PS-PVC-PS, all stretchable layers.

11. Film according to claim 2, characterized in that it comprises PS-PVC-EVA.

12. Film according to claim 2, characterized in that it comprises PE-PVC-PE.

13. Film according to claim 2, characterized in that it comprises PE-PVC-PS.

14. Film according to claim 2, characterized in that it comprises PE-PVC-EVA.

15. Film according to claim 1, characterized in that an antifogging substance (lipophilic and hydrophilic anticondensation agent) is added.

16. Film according to claim 1, characterized in that it is obtained by tubular bubble coextrusion.

17. A plant for the manufacture of film according to claim 1.
